(19) United States
(12) Patent Application Publication
(10) Pub. No.: US 2004/0103857 A1
(43) Pub. Date: Jun. 3, 2004

(54) Connection for attachments on a hand-held machine tool operated by an internal combustion engine, especially a motor-driven chain saw

(75) Inventor: Olaf Kruse, Glinde (DE)

Correspondence Address: Nicholas J. Tuccillo, Esq., McCormick, Paulding & Huber LLP, CityPlace II, 185 Asylum Street, Hartford, CT, 06103, US

(73) Assignee: DOLMAR GmbH, Hamburg (DE)

(21) Appl. No.: 10/616,856

(22) Filed: Jul. 9, 2003

(30) Foreign Application Priority Data
Jul. 12, 2002 (DE) 202 11571.2

(51) Int. Cl. F02B 75/12

(52) U.S. Cl. 123/1 R

(57) ABSTRACT

In order to provide a hand-held machine tool (100), especially a motor-driven chain saw, with a combustion engine drive (116) and a generator (102) for supplying voltage to electrical consumers, to which external electrical consumers can be connected in a simple fashion, it is proposed that the generator (102) has a connection for attachments (104) for external consumers.

The invention relates to a hand-held machine tool operated by an internal combustion engine having the features specified in the preamble of claim 1.

Known hand-held machine tools of this type are generally always used when there is no possibility of supplying current to electric-motor-driven hand-held machine tools.

It is known that combustion-engine operated hand-held machine tools, especially motor-driven saws or motor-driven disk grinders can be equipped with generators to produce electrical energy (current) by means of which small internal consumers of the hand-held machine tools, such as handle heaters may be supplied.

However, practice shows that there are a large number of cases of application where it is logical to be able to connect further, primarily external consumers. A known case of application, for example is the area of the fire brigade and technical assistance where it would be particularly useful if, in the dark, tree cutting using the motor-driven saw could be illuminated for the safety of the machine operator.

A disadvantage here is that so far no known solutions exist whereby hand-held, combustion-engine operated hand-held machine tools can be connected to external consumers.

The object of the invention is thus to provide a hand-held machine tool operated by an internal combustion engine, especially a motor-driven chain saw, to which external electrical consumers can be connected in a simple fashion.

This object is solved according to the invention on a hand-held machine tool operated by an internal combustion engine, especially a motor-driven chain saw, having a generator for supplying electrical consumers which are arranged inside the hand-held machine tool, by the generator having a connection for attachments for at least one external consumer.

In a preferred development of the invention, the connection for attachments is arranged in the housing of the hand-held machine tool operated by an internal combustion engine. In addition, the connection for attachments can be arranged on a flexible cable which is affixed to the housing of the hand-held machine tool operated by an internal combustion engine.

In this case, the connection for attachments according to the invention can be executed as a plug socket or as a plug socket with a protective cover.

According to a further preferred embodiment, it is provided that the connection for attachments is a plug socket or a plug connection with inductive energy transfer. It is hereby made possible that the energy is transferred inductively from the generator to the external consumer at the plug/plug socket connection. This has the advantage that the working safety or operating safety of the machine is substantially increased since a short circuit or unintentional contact between the voltage-carrying lead and the operator is avoided.

In a further preferred embodiment of the invention an electronic component can be arranged between the generator and the connection for attachments. According to the invention it is thereby possible to arrange a switch or a rectifier element or an overvoltage protection element.

The electronic components can be used individually or alternatively in combination.

A number of advantages are obtained from these preferred embodiments. Thus, the hand-held machine tool operated by an internal combustion engine according to the invention having the characterising features of the main claim has the advantage compared with the prior art that attachments can be connected at any time to non-electrically operated hand-held machine tools. For example, a lamp can be connected as an attachment via the connection for attachments.

It is furthermore possible in an advantageous fashion, for example, to adequately replace the handle heating supplied from the generator unit and to completely or partially install heating for the machine operator via externally connected heated glove systems, such as are known from motor sport. The generator unit of the handle heating used so far can be built unchanged and provided with the external connection for attachments. By dispensing with the handle heating in the hand-held machine tool operated by an internal combustion engine, especially in the motor-driven chain saw, heating films and cables can be eliminated, whereby simpler manufacture and assembly and consequently a reduction in costs can be achieved.

In addition, when using rectifier elements with the connection for attachments, it is possible to use halogen lamps which are affixed to the handle unit or worn on a helmet.

Further preferred embodiments of the invention are obtained from the other features specified in the dependent claims.

The invention is explained in greater detail below in an exemplary embodiment with reference to the drawings. In the figures:

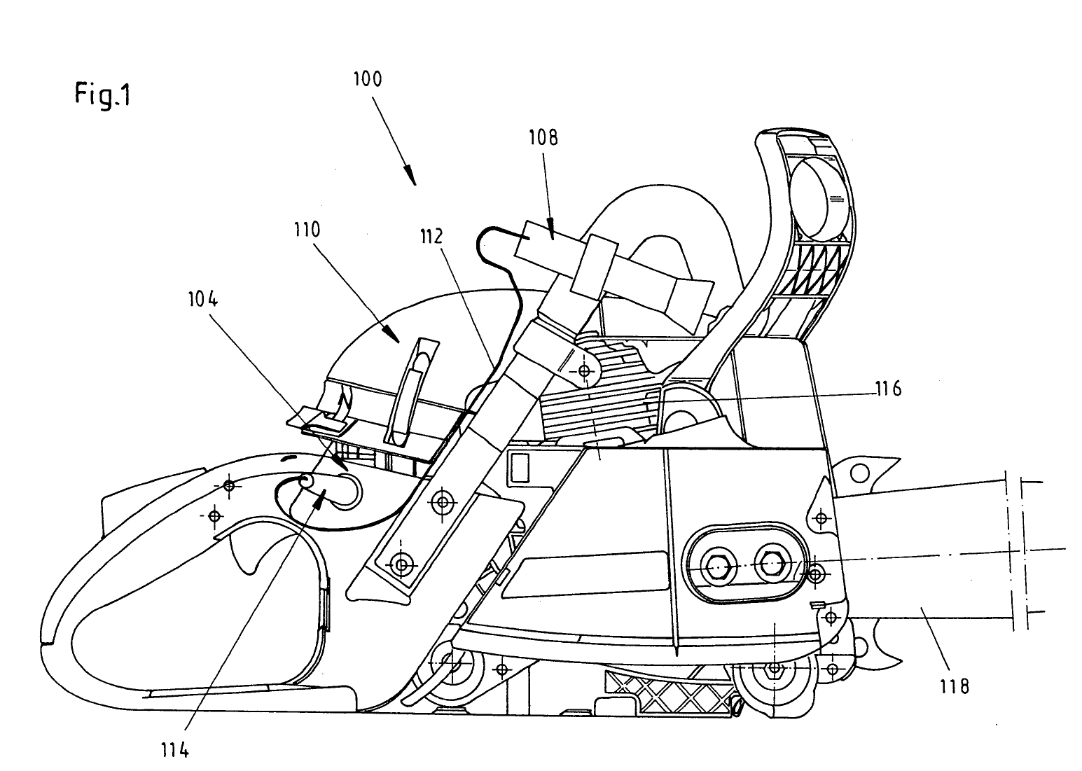

FIG. 1 is a schematic diagram of a motor-driven chain saw operated by an internal combustion engine with an attachment connected via a connection for attachments and

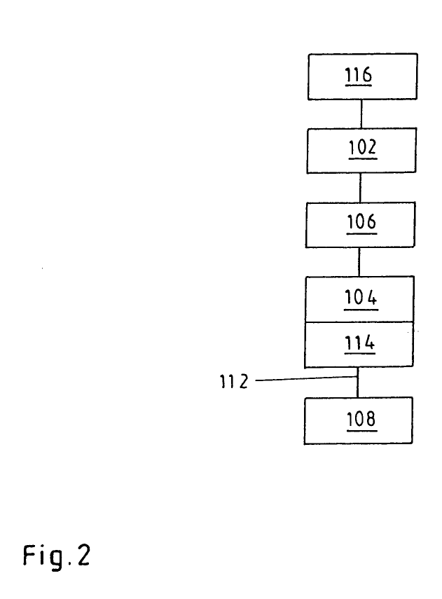

FIG. 2 is a block circuit diagram between the combustion engine drive of the motor-driven chain saw and the connection for attachments.

FIG. 1 shows a motor-driven chain saw 100. The motor-driven chain saw 100 substantially consists of a known combustion-engine motor unit 116, a housing 110 and a cutting tool 118. Near the handle of the motor-driven chain saw 100 there is a connection for attachments 104. In FIG. 1 the connection for attachments 104 is executed as a plug socket. Alternatively, the connection for attachments 104 can be executed as a complete plug socket for equipment with a protective cover or preferably affixed to a flexible cable at the housing 110 of the motor-driven chain saw.

In the connection for attachments 104 there is a plug 114 which supplies an attachment, especially a lamp 108, via a lead 112.

The lamp 108 shown in FIG. 1 stands as an example for all possible connectable attachments. These also include heatable gloves or helmet lamps and the like.

The necessary electrical energy is produced from the motor 116 via a generator 102 not shown in detail and the generator is connected to the connection for attachments 104 in an inherently known fashion in the interior of the motor-driven chain saw 100.

For clarity the block circuit diagram in FIG. 2 shows the supply of the attachment 108 with the necessary energy. Starting from the motor 116 via the generator 102, an electronic component 106 can be arranged between the generator 102 and the connection for attachments 104. This electronic component 106 can be executed as a switch or a rectifier element or as an overvoltage protection element. The electronic components 106 can naturally be used in combination. The electronic component 106 is followed by the connection for attachments 104 into which the plug 114 can be inserted directly. An existing lead 112 connects the plug 114 to the attachment 108. The lead 112 as a suitable connection can also be omitted whereby an external consumer can then be connected directly to the plug 114.

Reference List

| | |
|---|---|
| 100 | Hand-held machine tool (motor-driven chain saw) |
| 102 | Generator |
| 104 | Connection for attachments |
| 106 | Electronic component |
| 108 | Lamp |
| 110 | Housing |
| 112 | Lead |
| 114 | Plug |
| 116 | Motor |
| 118 | Cutting tool |

1. A hand-held machine tool (100), especially a motor-driven chain saw, comprising a combustion engine drive (116) and a generator (102) for supplying voltage to an electrical consumer, characterised in that said generator (102) has a connection for attachments (104) for an external consumer.

2. The hand-held machine tool according to claim 1, characterised in that said connection for attachments (104) is arranged in the housing (110) of said hand-held machine tool (100).

3. The hand-held machine tool according to claim 1, characterised in that said connection for attachments (104) is arranged on a flexible cable affixed to said housing (110) of said hand-held machine tool (100).

4. The hand-held machine tool according to any one of the preceding claims, characterised in that said connection for attachments (104) is a plug socket.

5. The hand-held machine tool according to any one of the preceding claims, characterised in that said connection for attachments (104) is a plug socket with a protective cover.

6. The hand-held machine tool according to any one of the preceding claims, characterised in that said connection for attachments (104) is a plug socket (114), a plug or a plug connection with inductive energy transfer.

7. The hand-held machine tool according to any one of the preceding claims, characterised in that between said generator (102) and said connection for attachments (104) there can be arranged one or a plurality of electronic components (106).

8. The hand-held machine tool according to claim 7, characterised in that said electronic component (106) is a switch.

9. The hand-held machine tool according to claim 8, characterised in that said electronic component (106) is a rectifier element.

10. The hand-held machine tool according to claim 7, characterised in that said electronic component (106) is an overvoltage protection element.

11. The hand-held machine tool according to any one of the preceding claims, characterised in that a lamp (108) may be connected to said connection for attachments (104) by means of a plug (114) via a lead (112).
